(19) United States
(12) Patent Application Publication
(10) Pub. No.: US 2026/0161137 A1
(43) Pub. Date: Jun. 11, 2026

(54) METHOD FOR TESTING THE KINEMATIC DISPLAY CHAIN IN A WATCH OR WATCH HEAD DOWNSTREAM OF ITS OSCILLATOR

(71) Applicant: OMEGA SA, Biel/Bienne (CH)

(72) Inventors: Alexandre HUNDZINGER, Neuchâtel (CH); Anthony HAEBERLI, Bienne (CH); Justin ACHARD, Cortaillod (CH)

(73) Assignee: OMEGA SA, Biel/Bienne (CH)

(21) Appl. No.: 19/363,814

(22) Filed: Oct. 21, 2025

(30) Foreign Application Priority Data
Dec. 11, 2024 (EP) 24219205.2

(51) Int. Cl. G04D 7/00

(52) U.S. Cl. CPC G04D 7/006; G04D 7/004

(57) ABSTRACT

A method for testing the display of a watch head, in which the watch head is kept running continuously for 24 hours, an initial optical image of the hands is taken at an initial time with reference to fixed points; at least 24 hours later, at a final time measured on a reference clock, a final optical image of the hands is taken with reference to the fixed points, the positions of the hands at the initial and final times are determined by visual recognition means, the difference between the reference position on the reference clock and the actual position of the hands is calculated, and the value of the measured state deviation is displayed.

### CROSS-REFERENCE TO RELATED APPLICATIONS

This application claims priority to European Patent Application No. 24219205.2, filed on December 11, 2024, the entire contents of which are incorporated herein by reference.

### Technical Field of the invention

The invention relates to a method for testing the kinematic display chain in a watch or watch head downstream of its oscillator, simultaneously with the tests commonly conducted in the horology field, on an array of testing stations.

The invention relates to the field of horological running and state testing.

### Technological background

To guarantee a certain level of chronometric precision, it is essential to carry out running tests before finishing a watch head or a watch. In mechanical watches, these running tests focus on the quality of the oscillator. However, display precision, which is addressed by state testing, relates not only to the oscillator (or regulator), but also to the motor organ, the display setting mechanism, and all the trains, in particular the finishing train and the drives for the indicators, particularly the hands. Any slack in the gears leads to uncertainty in the visual measurement of these indicators or hands. Slippage of the indicators or hands on their pivots is generally much greater than the measurement uncertainty. Lastly, transmission errors (number of teeth) are among the most critical cases and can lead to a loss of over 100 seconds per day if a tooth is lost.

The performance of the best oscillator can therefore be masked by a purely mechanical or kinematic defect: out-of-roundness, lack of lubrication, damaged or missing teeth, gear slack, slippage on the pivot, rubbing of the hands, or other flaws.

It is therefore important to carry out display synchronisation testing on a watch head or watch comprising a mechanical movement. Moreover, conventional display testing when setting the time does not generally relate, by design, to the transmission of the display when the watch is functioning.

Since the kinematic display chain is tested separately, measurement testing of the state of a watch or watch head can be carried out without the watch or watch head display, and thus only on the regulator.

### SUMMARY OF THE INVENTION

The invention therefore proposes to carry out a display synchronisation test to avoid the delivery of a timepiece comprising any of these defects.

To this end, the invention relates to a method according to claim 1.

### BRIEF DESCRIPTION OF THE FIGURES

The purposes, advantages and characteristics of the invention will become clearer from the following detailed description, with reference to the appended drawings, in which:

FIG. 1 illustrates a particular sequence that is well suited to the use of the invention, with operations carried out in parallel over time. The top line shows winding operations; the next line shows a sequence of operations, in movement, incorporated in a watch head, these operations involving magnetic behaviour testing, daily precision acoustic testing and water resistance testing operations. The bottom line in the figure relates to optical testing, while the middle part of the figure provides details about the first of the daily precision acoustic measurement operations, with a sequence of measurements in the various standardised chronometric positions, at two different temperatures;

FIG. 2 is a diagram showing the timestamps for the ticks and tocks of the movement, with the times for the first and last releases, the impulse and the drop.

### DETAILED DESCRIPTION OF THE INVENTION

The invention relates to a method for testing the kinematic display chain of a watch or a watch head downstream of its oscillator, using simultaneous measurement of the running of a watch or a watch head by capturing an optical image of the hands and continuous or near-continuous acoustic measurement on an array of testing stations.

According to this method, said watch or watch head is kept running continuously for a measurement time TM of at least 24 hours, ideally for several days depending on the desired precision of the measurement, either by providing this watch or watch head with an energy source capable of keeping it running for at least said measurement time TM, that is, running for at least 24 hours, or by equipping said testing station with a winding and/or shaking device with which said watch or watch head is wound or shaken to rewind it for at least this measurement time TM of at least 24 hours, or even both by providing the watch or watch head with a source of energy capable of a certain power reserve and by equipping said testing station with a winding and/or shaking device with which said watch or watch head is wound or shaken to rewind it to keep the measurement time TM to at least 24 hours.

At an initial time t0, at least one initial optical image is taken of the hands on this watch or watch head, with reference to fixed points on the watch or watch head and/or to fixed points on a tool carrying the watch or watch head.

Directly after taking the initial image, the watch or watch head is placed in an apparatus with a reference clock and a system for detecting ticks and tocks, in order to carry out continuous or near-continuous acoustic measurement of the regulator for the entire period of time t.

A continuous or near-continuous acoustic measurement is thus taken of the oscillator or of the regulator in said watch or watch head between the initial optical image and the final optical image, making it possible to determine the running deviation.

At the end of said measurement time TM, the running of the watch is acoustically evaluated by counting the number of ticks and of tocks relative to the elapsed time.

The watch can undergo a great deal of potential stress that can affect its running between the two state images, such as dynamic movement, static movement, temperature and humidity.

And, at this final instant t0+t measured on a reference clock, at least one final optical image of the hands of the reference watch or watch head is taken at fixed points on the watch or watch head, and/or respectively at fixed points on the tool. The positions of these hands are determined at the initial time t0 and at the final time t0+t by visual recognition means, with which the testing station is equipped. The difference between, on one hand, the reference position relative to the reference clock and, on the other hand, the actual position of the hands is calculated and the value of the measured state deviation is displayed.

Optical measurement therefore makes it possible to test the chronometry of the motor + oscillator part and the display part of the watch, whereas acoustic measurement only makes it possible to test the chronometry of the motor + oscillator part of the movement.

To determine the synchronisation of the display, the difference between the running of the watch or watch head determined by taking the optical state of the display and the running of the watch determined by acoustically measuring the ticks and tocks in a continuous or near-continuous manner is calculated. This difference will be close to 0 if the watch is free of any display problems, irrespective of the performance of its oscillator.

It is understood that the invention relates to a comparison of the time counted by the acoustic regulator and the time counted by the display. The length of this time only affects the precision of the desired comparative measuring.

In an advantageous embodiment of the method, each optical measuring operation is carried out by taking a number of images, averaging the hand positions identified by each of the images in order to reduce the measurement uncertainty.

More specifically, according to this method, between the initial time and the final time, the watch or watch head is subjected to dynamic spatial movements, windings, wait times in standard chronometric positions, or any other stress on the regulator and on the display mechanism of the watch or watch head in accordance with official standards such as the ISO 3159 standard, or internal or other standards.

More specifically, the watch or watch head is subjected to spatial movements in order to carry out running tests in the standardised chronometric positions and to determine the values of the running deviation in said standardised chronometric positions, and the values of the running deviation, on one hand, and the value of the state deviation, on the other hand, are compared to internal specifications in order to authorise or prohibit further manufacture of the watch or watch head.

More specifically, intermediate running checks are carried out in the standard chronometric positions using instantaneous or continuous acoustic measurements, in part or in full.

Even more specifically, at least one intermediate time between this initial time and this final time, at least one intermediate test is carried out in which at least one intermediate optical image is taken of the hands of the watch or watch head with reference to said fixed points, the positions of the hands at this initial time and at this intermediate time are determined by the visual recognition means, the difference between, on one hand, the reference position relative to said reference clock and, on the other hand, the actual position of the hands is calculated, and the value of the state deviation measured at this intermediate time is displayed.

More specifically, between the initial time and the final time, the watch or watch head is run through an oven under predetermined time, temperature and humidity conditions.

More specifically, said watch or watch head is enclosed and locked in a handling box, which is chosen to be transparent, and all the handling operations between said initial time excepted and said final time are carried out with said watch or watch head in said handling box.

Even more specifically, the at least one initial image is taken before inserting the watch or watch head into the handling box, and the at least one final image is taken after extracting the watch or watch head from the handling box.

In one particular embodiment, this testing method is applied to a mechanical watch.

It should be noted that in the field of horology, acoustic measurements are referred to as instantaneous (generally 40 seconds), whereas in the case of the invention, these acoustic measurements are continuous or near-continuous to ensure that each tick-tock of the watch is counted over the entire observation time between the two visual state images.

A specific, but by no means limiting, embodiment of the method according to the invention is described in detail below.

METAS N001 v 1.2, the new requirements for certifying mechanical movements and watches resistant to magnetic fields of 1.5 T (15,000 G), are compatible with the optical-acoustic measurement of watches and watch heads. More specifically, a technology is used based on their preparation in acoustic testing enclosures that are universal and compatible with watch heads, as described in particular in documents EP3410234, EP3812847, EP22209439.3, CH001445/2022, EP22209441.9 and CH001404/2022, for a precision of ± 50 ms/day. These testing enclosures, often designed for sets of ten or more, are ideal for holding watches or watch heads.

Display synchronisation is tested by taking an optical measurement of the state of the second and/or minute hands. In a “seconds and minutes” variant, the display synchronisation is tested over a period of approximately six days (at least 120 hours), so as to minimise measurement uncertainty.

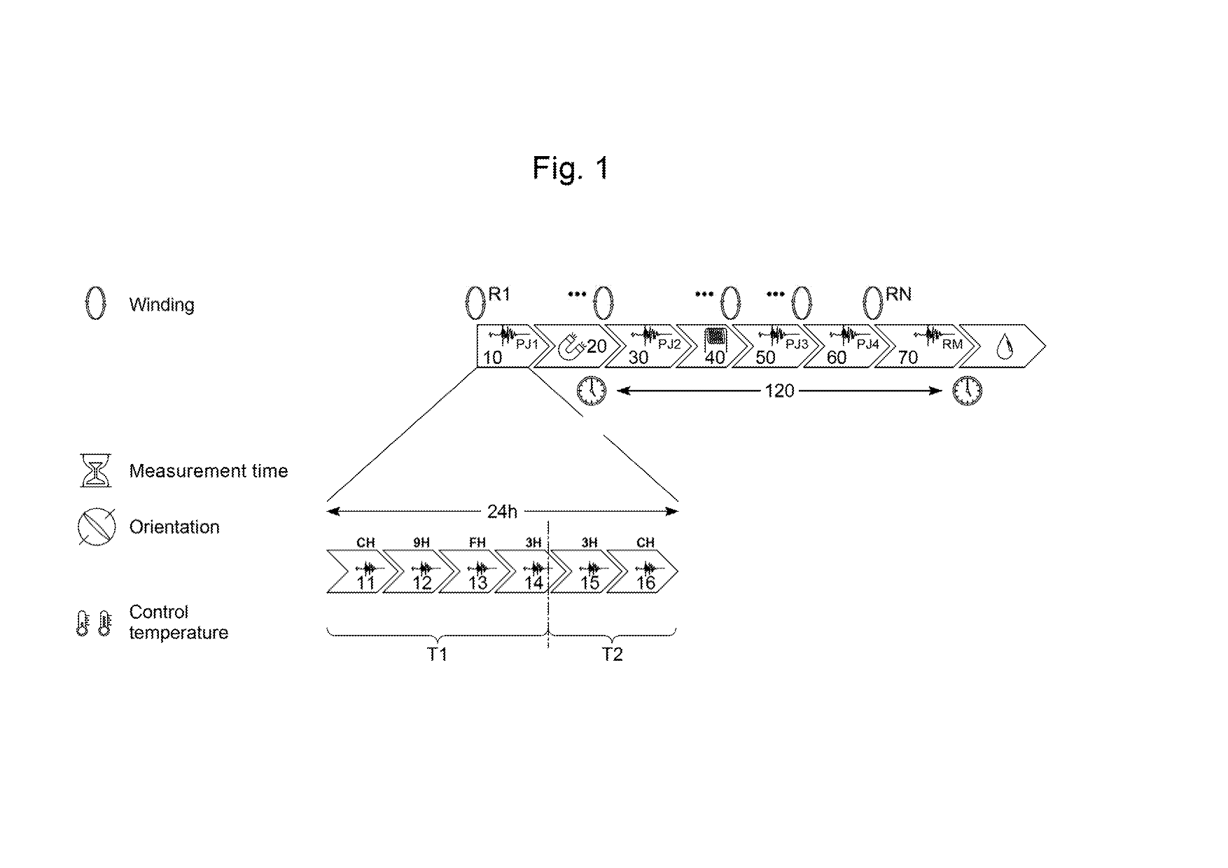

FIG. 1 illustrates a particular sequence that is well suited to the use of the invention. The top line shows a sequence of winding operations R1, …, Rn, to keep the watch running: at the start of each cycle described in the METAS N001 requirements, winding is carried out. Below that, a sequence of operations can be seen, which are magnetic behaviour testing, daily precision testing, water resistance testing operations, the order and number of which can be changed without departing from the invention within the limits of the METAS N001 requirements.

In preparation for watch head testing to METAS N001 requirements, the watch head is put in an acoustic testing enclosure as has also been described above.

Preferably, each acoustic testing enclosure holds a set, for example of ten watch cases; the whole set then undergoes these final running and state tests.

The sequence of operations is preferably carried out automatically and robotically: each spatial handling operation is applied to the acoustic testing enclosure and each test under controlled temperature or controlled humidity, or controlled pressure, or other, is run on the entire enclosure.

The first testing operation 10 is a chronometric test of the daily precision PJ1, with the acoustic testing enclosure in different spatial orientations and in which microphones, particularly piezoelectric microphones, are used in the acoustic testing enclosure in contact with the watch head, to listen to the ticking and isolate the characteristic moments of a mechanical watch oscillator: release, impulse, drop, common to Swiss pallet escapements and to co-axial escapements, even if these times do not correspond exactly to contacts between the same surfaces. This first testing operation 10 is conducted in accordance with the METAS N001 requirements with regard to temperatures and positions.

This is followed by:

a functional testing operation in a magnetic field 20,

a second chronometric testing operation 30 similar to the first 10 as described above, and in accordance with the METAS N001 requirements with regard to temperature,

a demagnetising operation 40,

a third chronometric testing operation 50 similar to the first 30 as described above, and in accordance with the METAS N001 requirements with regard to temperature,

a fourth chronometric testing operation 60 similar to the first 10 as described above, and in accordance with the METAS N001 requirements with regard to temperature,

a power reserve testing operation 70 (cycle 7 in METAS N001),

before carrying out a water resistance test.

In parallel with the acoustic tests, the bottom line shows the optical tests, which are advantageously performed when handling the watch head to confirm or invalidate display synchronisation.

Display synchronisation is tested by taking an optical image of the state of the second and minute hands. Optical hand recognition uses a series of continuous measurements over a 60-second observation period, which makes it possible to eliminate optical imaging artefacts, to determine the gain or loss of a watch head or of a watch between two states. During this period, each acquisition is dated, and a shape-matching algorithm searches for the watch head or watch, in position and orientation, and the hands.

The technology used in the acoustic testing enclosures can be used with watch heads to measure a precision of +/- 50 ms/day or even +/- 10 ms per day if the reference clock in each enclosure is calibrated prior to measuring.

The acoustic measurement and processing system and its use are described in detail in §0014 to §0021 and in FIGS. 4 to 6 of document EP3812847. To sum up, the purpose of the continuous acoustic measurement system is to time-stamp the shocks of the movement's oscillator. A control unit processes these time stamps and measures the daily precision of the watch heads in the acoustic testing enclosure.

For reasons of data quantity and energy consumption (processor calculation), the signals corresponding to the watch heads mounted in the acoustic testing enclosure, in particular ten, are temporally broken up into signal trains. The number of activated channels and the length of the signal trains can be adapted according to the on-board firmware. Each signal train must last a minimum of five seconds, to allow the algorithm to configure itself and be precise enough to detect the drop; about two seconds are used to detect the noise thresholds and the frequency class, and about three seconds to accumulate enough data to estimate the impulse and the drop by overlapping.

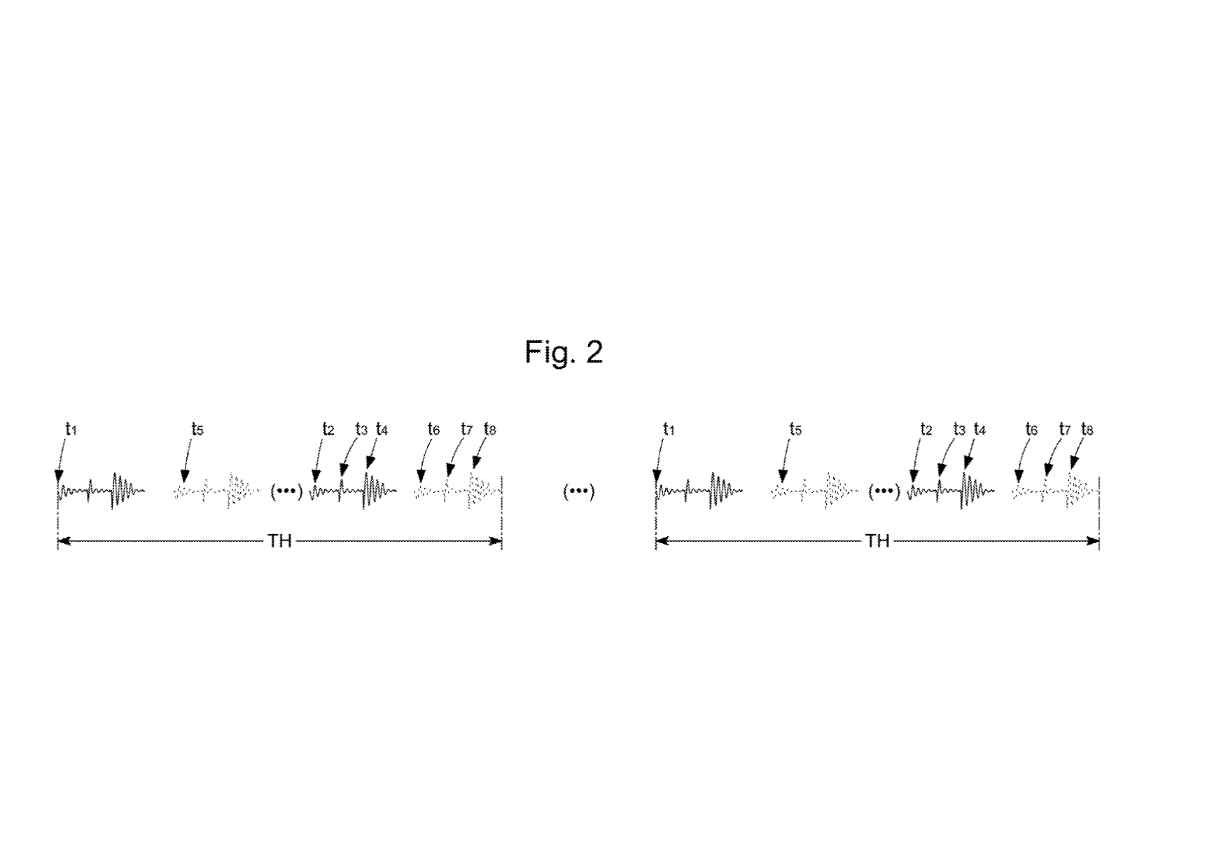

The on-board algorithm then determines the time stamp of the tick and tock shocks. At the beginning of each measurement train, the algorithm detects the frequency by classifying it in 0.5 Hz steps between 2 Hz and 5 Hz, then detects the noise level in the silent zones to determine the threshold for detecting the release. The release of the ticks and tocks are identified by a threshold crossing. As the information is a modulo of the frequency of the movement, the first and last releases are retained. The drop and the impulse are time-stamped by overlapping the signals. These timestamps are therefore only available for the last ticks and tocks, in order to have a maximum amount of data for the overlap. FIG. 2 shows the tick time stamp as a solid line, and the tock time stamp as a broken line, and shows only the first tick-tock and the last tick-tock in each measurement train. Each measurement train has a time TH, for example 10 seconds, and the measurement trains are separated from each other. For the tick timestamp, t1 is the first release, t2 the last release, t3 the detection of the impulse, t4 the detection of the drop; for the tock timestamp, t5 is the first release, t6 the last release, t7 the detection of the impulse, t8 the detection of the drop.

The acoustic measurement of daytime running using the acoustic testing enclosure is validated by comparative measurements with the optical measurements taken in this way. A relatively rapid convergence (after about 24 hours) was observed between the acoustic measurements and the optical measurements.

The use of such an optical-acoustic measurement method in parallel over a period of 120 hours makes it possible to arrive at a display synchronisation measurement uncertainty on the order of 5 seconds/day for the minute hand and 100 ms for the second hand, thereby ensuring reliable detection of possible display malfunctions.

A typical, but non-limiting, operating procedure comprises the following steps:

A Placement in an acoustic testing enclosure

B Winding

C 24-hour wait

D Daily precision testing 01

E Winding

F Standard preparation

G Functional testing in magnetic field

H Take MS state 0 hours

I Placement in an acoustic testing enclosure

J Daily precision testing 02

K Demagnetising

L Winding

M 24-hour wait

N Daily precision testing 03

O Winding

P 24-hour wait

Q Daily precision testing 04

R Winding

P

S 48-hour wait

T Standard preparation

U Take MS state 0 hours

V RM testing

W SA testing

X Water resistance testing

Y Putaway.

In particular, operations A to S, with the exception of operations G and H, are carried out on the watch head in an acoustic testing enclosure, which is subjected to movements imparted by a shaker, as well as to scheduled runs in an oven. In short, the invention makes use of technical preparations: standard compatible ones for vision and handling for magnetic field testing and acoustic testing enclosures, which have already been developed, in order to meet METAS N001 requirements and guarantee a perfectly secure testing cycle with no human intervention likely to bias any of the tests.

1. A method for testing the kinematic display chain of a watch or watch head downstream of its oscillator, simultaneously with tests on an array of testing stations, in which a simultaneous measurement of the running of a watch or watch head is used by taking the optical state of the hands and continuous or near-continuous acoustic measurement on an array of testing stations, and said watch or watch head is kept running continuously for a measurement time TM of at least 24 hours, either by providing said watch or watch head with an energy source capable of keeping it running for at least said measurement time TM or by equipping said testing station with a winding and/or shaking device with which said watch or watch head is wound or shaken to reset it for at least said measurement time TM.

2. The testing method according to claim 1, wherein, at an initial time t0, at least one initial optical image of the hands of said watch or watch head is taken with reference to fixed points on said watch or watch head and/or to fixed points on a tool wherein said watch or watch head is enclosed and locked, and at least one final optical image of the hands of said watch or watch head is taken after at least said measurement time TM at a final time measured on a reference clock with reference to fixed points on said watch or watch head and/or to fixed points comprised in said tool, the positions of the hands at the initial time and at the final time are determined by visual recognition means with which the testing station is equipped, the difference between, on one hand, the reference position on the reference clock and, on the other hand, the actual position of the hands is calculated, and the value of the measured state deviation is displayed.

3. The testing method according to claim 1, wherein a continuous or near-continuous acoustic measurement is taken of the oscillator or of the regulator in said watch or watch head between the initial optical image and the final optical image, making it possible to determine the running deviation.

4. The testing method according to claim 3, wherein, at the end of said measurement time TM, the running of the watch is acoustically evaluated by counting the number of ticks and of tocks relative to the elapsed time.

5. The testing method according to claim 1, wherein, between said initial time and said final time, said watch or watch head is subjected to dynamic movements in dynamic space, so as to wind said watch or watch head, and/or to conduct running tests in the standard chronometric positions.

6. The testing method according to claim 1, wherein, between the initial time and the final time, the watch or watch head is subjected to stoppages in standardised chronometric positions, and/or to any other stress for the regulator and the display mechanism of the watch or watch head.

7. The testing method according to claim 5, wherein said watch or watch head is subjected to spatial movements in order to carry out running tests in the standardised chronometric positions and to determine the values of the running deviation in said standardised chronometric positions, and said values of the running deviation, on one hand, and said value of the state deviation, on the other hand, are compared to internal specifications in order to authorise or prohibit further manufacture of said watch or watch head.

8. The testing method according to claim 5, wherein said running checks are carried out in the standardised chronometric positions using acoustic measurements.

9. The testing method according to claim 1, wherein, between said initial time and said final time, said watch or watch head is run through an oven under predetermined time, temperature and hygrometry conditions.

10. The testing method according to claim 1, wherein said watch or watch head is enclosed and locked in a handling box, which is chosen to be transparent, and all the handling operations between said initial time excepted and said final time are carried out with said watch or watch head in said handling box.

11. The testing method according to claim 10, wherein said at least one initial image is taken before inserting said watch or watch head into said handling box, and said at least one final image is taken after extracting said watch or watch head from said handling box.

12. The testing method according to claim 1, wherein the method is applied to a mechanical watch.
